(19) United States
(12) Patent Application Publication
(10) Pub. No.: US 2011/0027158 A1
(43) Pub. Date: Feb. 3, 2011

(54) Calcined Tincal Production Method by Calcination Autogenic Grinding and Separation (CASG) Method in a Single Step

(75) Inventors: Orhan Yilmaz, Ankara (TR); Yucel Yalcinoglu, Balgat/Ankara (TR); Tanzer Ergul, Yenimahalle/Ankara (TR); Tumay Uludag, Ankara (TR); Bilal Senturk, EtimesgutAnkara (TR); Hasan Akcin, Cankaya-Oran Ankara (TR); Ibrahim Kayandan, Balikesir (TR); Celal Demirbag, Seyitgazi/Eskisehir (TR)

Correspondence Address: COLLEN IP, THE HOLYOKE MANHATTAN BUILDING, 80 SOUTH HIGHLAND AVENUE, OSSINING, NY, 10562, US

(73) Assignee: ETI MADEN ISLETMELERI GENEL MUDURLUGU, 06440 Ankara (TR)

(21) Appl. No.: 12/446,090

(22) PCT Filed: Oct. 17, 2007
(86) PCT No.: PCT/IB07/54225

§ 371 Date: Oct. 13, 2010

(30) Foreign Application Priority Data
Oct. 20, 2006 (TR) 2006/05914
May 17, 2007 (TR) 2007/03372

(51) Int. Cl. C01B 35/12

(52) U.S. Cl. 423/279

(57) ABSTRACT

This invention relates to production of micronized calcined tincal having a high content as a result of a succession of procedures consisting of: hardening of earth minerals due to lose of water during subjecting coarse tincal ore (Na₂B₄O₇-10H₂O) to heat treatment in rotary furnace with flights; forming of swollen soft, expanded structure of tincal ore caused by calcination and consequently being calcined followed by purification from impurities in a high rate in a way subjecting calcined tincal to pneumatic separation procedure by means of hot air used for calcination process after autogenic grinding effect of dried and hardened clays on swollen ore and obtaining micronized calcined tincal with high efficiency. The invention also relates to the production of compacted calcined tincal product with increased density in the second step as result of compacting micronized calcined tincal with low density under pressure.

This invention; relates to production of micronized calcined tincal having a high content as a result of a succession of procedures consisting of: hardening of earth minerals due to lose of water during subjecting coarse tincal ore (Na₂B₄O₇.10H₂O) to heat treatment in rotary furnace with flights; forming of swollen soft, expanded structure of tincal ore caused by calcination and consequently being calcined followed by purification from impurities in a high rate in a way subjecting calcined tincal to pneumatic separation procedure by means of hot air used for calcination process after autogenic grinding effect of dried and hardened clays on swollen ore and obtaining micronized calcined tincal with high efficiency. The invention also relates to the production of compacted calcined tincal product with increased density in the second step as result of compacting micronized calcined tincal with low density under pressure.

Raw material: Run of tincal mine ore crushed to −50 mm,
Chemical formulation: Na₂B₄O₇.10H₂O

### Content: 20-28% B₂O₃

Bulk Density: 1.3 gr/cm³

### Particle Size: <50 mm

### Moisture: 3-8%

### Crystal Water: 10 mol H₂O

Impurity content: 25-45%

### Products Obtained:

### 1^{st} Step: Micronized Calcined Tincal

### Chemical Formulation: Na₂B₄O₇.(1-5)H₂O

### Content: 45-62% B₂O₃

Bulk density: 0.15-0.3 gr/cm³
Particle Size: <250 micron

### Moisture: 0-0.6%

### Crystal Water: 1-5 mol H₂O

Impurity content: 3-12%

### 2^{nd} Step: Compacted Calcined Tincal

Chemical formulation: Na₂B₄O₇.(1-5)H₂O

### Content: 45-62% B₂O₃

Bulk density: 0.75-1.0 gr/cm³
Particle size: <6 mm (size may be adjusted.)

### Moisture: 0-0.6%

Crystal water: 1-5 mol H₂O
Impurity content: 3-12%

### 1^{st} Step: Method for Production of Micronized Calcined Tincal;

The production of micronized calcined tincal with high content of B₂O₃ is accomplished by the method in which the earth mineral material hardens due to lose of water contained in the ore during calcinations of coarse tincal ore in a rotary furnace with flights, tincal ore has a brittle structure as a result of loss of moisture and water content and consequently expansion, expanded tincal is crushed by autogenic grinding impact of clay hardened in rotary furnace, micronized calcined tincal with low density is purified from the clay (impurities) in a high rate by subjecting to pneumatic separation by means of hot air used for calcination process.

### INDUSTRIAL APPLICATION OF PRODUCTION OF MICRONIZED CALCINED TINCAL PRODUCTION BY CALCINATION AUTOGENIC GRINDING AND SEPARATION METHOD IN A SINGLE STEP

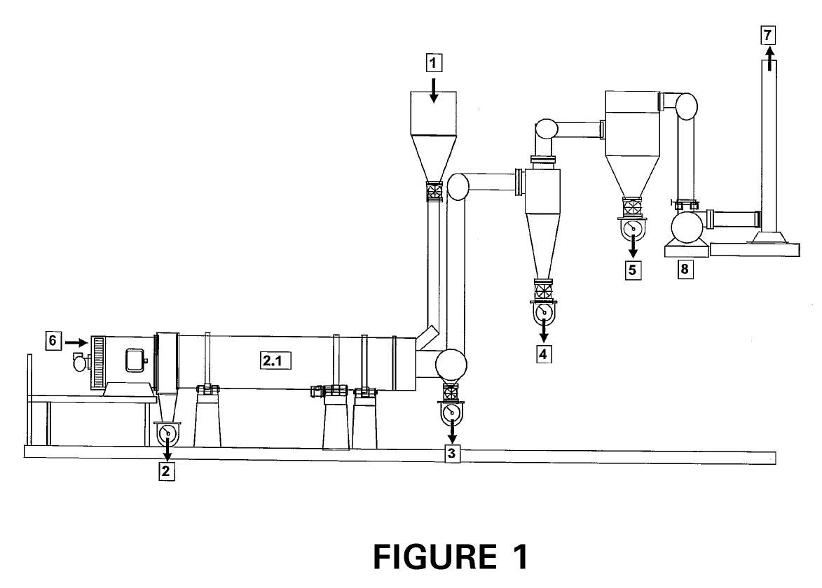

### List of Machines and Equipment Used in Production of Micronized Calcined Tincal (FIG. 1/2)

1 Run of mine ore feeding hopper
2 Waste output of furnace
2.1 Calcination kiln
3 Chimney exit at the end of furnace
4 Dust cyclone
5 Bag filter
6 Burner
7 Funnel for releasing into atmosphere
8 Air Fan

A calcination process is required to produce a micron size calcined tincal having 1-5 moles of crystal water. Interior design of the calcination furnace is important as affecting production quantity and quality. There must be flights swirling grains of ore inside the furnace attached to the liner of the furnace. These flights must be mounted at the interior lining of the furnace along the furnace as strips by intervals.

Inclination and rotation speed of the furnace are among the factors affecting the time for staying within the furnace and thickness of the liner and quantity of supply as well, thus production quantity and quality are also affected.

Preheating of equipment used in process is required prior to start of production.

Coarse tincal ore is prepared for calcination after it was crushed into pieces of −25 mm size; however it may be calcined by being crushed into larger size (−50 mm) Crushed coarse tincal ore is charged into the feeding hopper (1) and the process is put into operation.

The furnace is subjected to preheating by clean air sucked from the ambient air by a fan (8) and a burner (6) with temperature control in a process control manner. Calcination kiln (2.1) is arranged to thermal regime before charging.

According to crystal water rate of micronized calcined tincal to be produced (1-5 moles), operation temperature levels of the process are adjusted to the temperature ranges defined in the following and these temperature parameters are controlled by an automatic control system continuously. So, temperature values in the system are as follows:

| | Minimum | maximum |
|---|---|---|
| Furnace entry (hot head) | 300° C. | 550° C. |
| Middle of Furnace | 130° C. | 450° C. |
| Furnace exit (cold head) | 100° C. | 250° C. |
| Chimney | 70° C. | 200° C. |
| (between the furnace and dust cleaning unit) | | |
| Dust cleaning unit | 60° C. | 140° C. |

After completion of preheating, coarse tincal is fed to calcinations furnace in reverse flow (in the reverse direction of hot air flow) from the exit of the furnace (cold head).

Calcination furnace is an oven with reverse flow, thus supply of coarse tincal ore and flow of hot gas move in reverse direction.

Coarse mine ore is fed gradually by increasing until rated capacity is reached into rotary furnace by a system located under feeding bunker with weight/flow control. Quantity of feeding is determined based on the system capacity.

When operation is performed at the lower values of the defined temperature level, crystal water of final product is 5 moles; when operation is performed at the upper values micronized calcined tincal having about 1 mole crystal water is produced. In order to produce micronized calcined tincal including crystal water with the values between 1 to 5 moles, temperatures of the process must be adjusted to the values between minimum and maximum temperature values. Therefore; these temperature parameters must be controlled continuously by means of an automatic control system.

In addition; in order to produce micronized calcined tincal including crystal water with the desired values according to the process (1-5 moles), it will be convenient to apply heat treatment to coarse tincal in the rotary furnace with flights for 40-45 minutes. Temperature values of the chimney and dust cleaning unit within the process operation temperatures must be adjusted not to exceed the required temperature values for the heat treatment to be applied to coarse tincal in the furnace.

Coarse ore fed into the furnace is calcined after being exposed to heat treatment with removal of surface moisture and crystal water. The internal flights of furnace ensure swirling of the ore after it is raised to a certain height instead being rolled into the furnace and grinding of hardened clays in autogenic manner on expanded calcined tincal.

Calcined tincal ground to micron size by the method employed is forced to be driven toward chimney by air fan. Calcined tincal ground into micron size are separated there in three steps and average 250 micron sized calcined tincal is obtained at the furnace output (chimney) (3), under the dust cyclone unit (4) and under bag filter (5). The products produced in this way are stored in hoppers separately and in mixture as well after they are blended into a mixture. On the other hand, waste clay subjected to separation can not be dragged by fan owing to coarse particle size (−20 mm) and high specific density and taken from the output (2) at the side of the burning chamber of calcinations furnace. The clay with a content of 1 to 5% B₂O₃ in average is obtained from the output. The air calcined tincal in micron size is discharged into the atmosphere from the funnel (7).

Calcined tincal ground into micron size (−250 micron) and calcined clay are subjected to separation in the furnace using difference of density. Since bulk density (0.15-0.3 g/cm³) of calcined tincal pulverized into micron size is lower compared to calcined clay (1.0 g/cm³), it is conveyed by air flow to dust cleaning unit. Here, air and dust elements are separated from each other; thereby, micronized calcined tincal is stored as final product. Calcined clay is obtained from opening of the furnace because of its high density.

The impurities such as clay obtained from hot head of furnace (furnace entrance) are removed as waste comprising 1-5% B₂O₃.

First, surface moisture is evaporated upon contact of coarse tincal ore with the hot air inside the furnace and then a part of crystal water in the chemical composition of ore is separated based on temperature and duration to remain inside the furnace, and finally expanded ore blasts.

As the temperature in the dust cleaning unit is low, water removed from the ore and water vapor carried into the system via air and combustion gases in the dust cleaning unit condense. A part of condensed water vapor is absorbed by the micronized calcined tincal again and included by the same; thus increase in the crystal water in the body is seen.

During production by this method, important parameters requiring attention are as follows:
Temperatures of interior part inside calcinatory (hot head of furnace, middle and end of furnace),
Temperatures of chimney and dust cleaning unit,
Feeding quantity of coarse tincal ore,
Volume of hot gas,
Cycle of calcinatory.

By this invention, a new product called “micron sized calcined tincal”, with average values of impurities, 50-58% B₂O₃ content, 1-5 moles of crystal water, size of −250 mm, bulk density of 0.15-0.3 g/cm³ and 10 to 15% insoluble material content is produced ensuring temperatures of the process, and enriching basic run of mine of tincal ore with a maximum particle size of −25 mm, 20 to 28% content of B₂O₃ and 10 moles of crystal water, with a recovery of B₂O₃ content in a method of calcination and autogenic grinding and separation (CASG) in a single step.

### 2^{nd} Step: Method for Production of Calcined Compacted Tincal;

In the second step, the method for production of compacted, calcined tincal with increased bulk density is invented by compressing micron sized calcined tincal with low density between rotating discs (plates) under pressure followed by crushing, sieving and adjusting size of the product. The method has been applied in industrial scale.

### Application of the Compacted Calcined Tincal Production in Industry

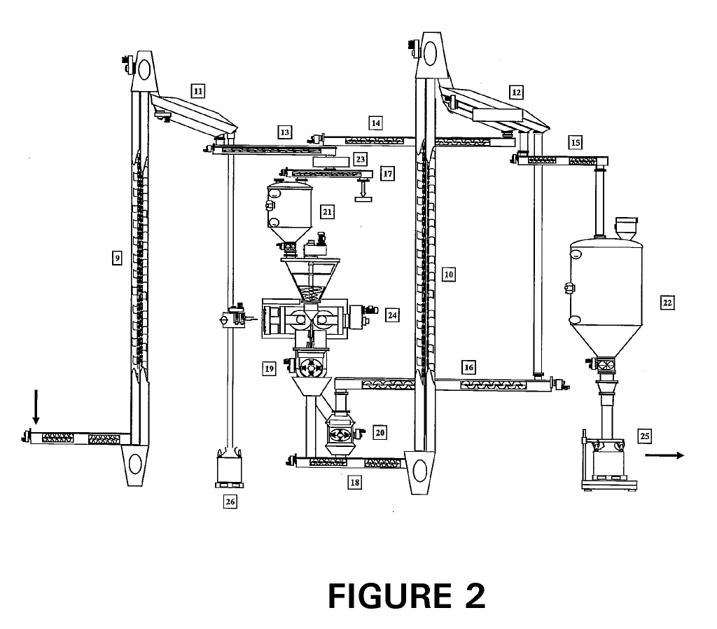

### List of the Equipment Used in Compacting of Calcined Tincal in Micron Size (FIG. 2/2)

9 Feeding elevator for calcined tincal in micron size,
10 Elevator for compacted, calcined tincal,
11 Coarse sieve, 6 mm mesh size of the sieve,
12 Product screen, double layer, three way
13 Screw conveyor
14 Screw conveyor
15 Screw conveyor
16 Screw conveyor
17 Screw conveyor (for wetting)
18 Screw conveyor
19 Crusher
20 Crusher (size adjuster)
21 Compactor, feed bunker
22 Product silo
23 Magnetic separator
24 Compactor
25 Bagging/packing system
26 Discharger from above coarse sieve

Calcined tincal with average size of −250 micron and 0.15-0.3 g/cm³ bulk density is conveyed from stock silos to coarse sieve (11) by the elevator (9). After sieving, it is conveyed to magnetic separator (23) by the conveyor (13). Following separation of magnetic particles, it is transferred to wetting system (17) where it is humidified at required rate and then conveyed to feed bunker (21) for compactor.

Humidified, calcined tincal in micron size is conveyed from compactor feed bunker to rotational discs of compactor (24). Cycles of helical supply system and those of compactors discs are well adjusted. Pressure applied to discs is also adjusted and these adjustments are designed to permit checking.

Calcined tincal entering in between compactor discs in micron size is extracted by the discs as compacted in slabs. The product extracted in slabs is crushed by the front crusher (19) coupled to compactor and then fed into size adjusting crusher (20). Compacted calcined tincal is carried by the conveyor (18) and elevator (10) to product screen (12) and sieved here. The product remaining on top of the screen is fed by the conveyor (16) back to crusher (20) to be crushed to size. The product passing through screen is fed back to the inlet of compacting system by conveyor (14). The medium sized product gathered in between layers of sifter is conveyed to product silo (22) by the conveyor (15) and prepared for sale after they are packed in bags in the packing unit (25). It is possible to adjust pressure value and mesh size of the screen by selection depending on bulk density and particle size of final product.

In order to increase amount of production in the compacting studies and to produce compacted calcined tincal at desired spec values, bulk density (0.15-0.3 g/cm³) is to be increased to level of 0.4-0.6 g/cm³ in average by applying pre-condensation process before entering into the compactor.

To meet this end:
Increase the density by mixing in the helix or another type mixer adding water or water vapor into the product in pulverized manner,
Mix with the materials (for example metal ball) having high density without abrasion nature within a tank adding dry water vapor in pulverized manner or without charging any additive,
Use two or more compactor in series (compressing the product—density of which is made approximately 0.4-0.6 g/cm³ by compressing in the 1^{st} compactor under low pressure—in the 2^{nd} compactor under high pressure).

In this way, air included in the micronized calcined tincal is discharged, thus dust is enabled to be inserted in the compactor by getting small in volume and compressed the dust with the bulk density of 0.4-0.6 g/cm³ in average.

Air included in the micronized calcined tincal and one of the reasons affecting negatively the compacting efficiency is discharged; thereby, the micronized calcined tincal pre-density of which is increased is compacted as a result of high pressure applied on it.

The micronized calcined tincal absorbs the water provided from the outside for bounding in order to increase the compacting efficiency of the micronized calcined tincal, which results in an increase in crystal water. However, in case the product is given in the rate of 1% by weight, it is not caused a significant increase in the crystal water of the product and remains between the desired tolerance values (Table 1).

Moreover, micronized calcined tincal has exothermal reaction when it contacts with water, which results in absorbing the water provided in pulverized manner as well as creating heat. This heat increase causes evaporation of a part of the water provided. The more water is provided the more increased in the crystal water is seen. Increase in the crystal water amount also increases the compacting efficiency of the micronized calcined tincal.

In the industrial applications for the micronized calcined tincal, when compacting process is performed without increasing pre-density of the product, compacting efficiency will be low. In this case, when compacting is preferred to be performed in a single step at least 15 ton/cm pressure to be applied on disc surfaces is required. However, as mentioned above, compacting process carried out with at least 4 ton/cm pressure to be applied on the disc surfaces in the 2^{nd} step by increasing the density of the product by removing air in the product in the 1^{st} step results in compacting in higher efficiency and capacity.

The change in physical characteristics of compacted, calcined tincal products obtained by compacting micron sized calcined tincal is as follows.

| | Micron sized | Compacted | Calcined |
|---|---|---|---|
| | calcined tincal | Calcined tincal | tincal |
| Bulk density (gr/cm³) | 0.15-0.3 | 0.4-0.6 | 0.75-1. |
| Particle size (mm) | 0.250 | −0.250 | −6.0 |

By this invention production of a new product called “compacted, calcined tincal” with particle size of −6 mm, bulk density of 0.75-1.0 g/cm³ and the same chemical properties with the micronized calcined tincal is achieved by compacting method using micron sized calcined tincal with particle size of −250 micron and bulk density of 0.15-0.3 g/cm³ as the raw feeding material.

TABLE 1
Chemical and physical properties of coarse tincal ore, micronized calcined tincal product,
compacted, calcined tincal product and clay (waste)

| | | | Micronized | Compacted calcined | Calcined waste |
|---|---|---|---|---|---|
| | | | calcined Tincal | tincal | (at the exit of |
| | Unit | Coarse tincal ore | (New Product) | (New Product) | furnace) |
| Chemical formulation | | Na₂B₄O₇•10H₂O | Na₂B₄O₇•(1-5)H₂O | Na₂B₄O₇•(1-5)H₂O | |
| B₂O₃ content | % | 20-28 | 45-62 | 45-62 | 1.0-5.0 |
| Insoluble material content | % | 25-45 | 3-12 | 3-12 | |
| Particle size | mm | −50 | −0.250 | −6 | −20 |
| Moisture | % | 3-8.00 | Max 0.6 | Max 0.6 | — |
| Bulk density | g/cm3 | 1.30 | 0.15-0.3 | 0.75-1.0 | 1.00 |
| Loss on ignition | % | Max. 45.0 | 8.0-30.0 | 8.0-30.0 | 22.0-37.0 |
| MgO | % | Max. 15.0 | 1-5.0 | 1-5.0 | 12.0-25.0 |
| CaO | % | Max. 10.0 | 1-5.0 | 1-5.0 | 8.0-25.0 |
| SiO₂ | % | Max. 15.0 | 1-3 | 1-3 | 10.0-30 |
| SO₃ | % | Max. 0.6 | 0.03-0.15 | 0.03-0.15 | 0.1-0.60 |
| Na₂O | % | Max. 12 | 15-29 | 15-29 | 1-12.0 |
| Fe₂O₃ | % | Max. 0.4 | Max 0.20 | Max 0.20 | 0.35-1.0 |
| Al₂O₃ | % | Max. 2.0 | Max 0.25 | Max 0.25 | 0.4-3.0 |

Note:
Analysis values are values obtained during coarse tincal calcinations study.
Value of humidity of micronized calcined tincal at 40° C. for 20 hours
Loss of ignition at 900° C. for 15 minutes

1. A micronized calcined tincal product characterized by containing 45-62% B₂O₃ content, 8.0-30.0% loss of ignition, 0.60% maximum moisture, −250 particle size and bulk density of 0.15-0.3 g/cm³ and
by having the chemical formulation of Na₂B₄O₇.(1-5)H₂O
as chemical and physical properties.

2. A micronized calcined tincal product according to claim 1 characterized with the content of impurities between 10-15% by weight (clay, dolomite), and by comprising the impurities consisting of 1-5.0% MgO, 1-5.0% CaO, 1-3.0% SiO₂, 0.03-0.15% SO₃, 15-29% Na₂O, maximum 0.20% Fe₂O₃, maximum 0.25% Al₂O₃.

3. A micronized calcined tincal product according to claims 1 and 2 comprising properties of varying according to chemical analysis values of the coarse ore subjecting to calcination, having exothermal reaction when it comes into contact with water as well as absorbing water, increasing its crystal water by absorbing moisture in the atmosphere.

4. A method for production of micronized calcined tincal product according to claims 1 to 3 characterized with the production procedure consisting of the steps of:
calcining coarse tincal ore in the rotary furnace with flights by being subjected to heat treatment,
micronizing calcined tincal by means of autogenic grinding in the rotary furnace,
subjecting to pneumatic separation procedure by means of hot air required for calcinations process in order to purify from clay (impurities) in a high rate.

5. A method for production of micronized calcined tincal according to claim 4 characterized with calcination process including the steps of
supplying coarse tincal ore into rotary furnace with integral flights in countercurrent (reverse) direction of hot air flow and
subjecting to heat treatment for 30 to 45 minutes within the rotary furnace,
separating crystal water in compliance with the reaction of:
Na₂B₄O₇.10H₂O+Heating-Na₂B₄O₇.(1-5)H₂O+(5-9)H₂O
obtaining a fragile and loose formed, low density structure,
hardening of clay (gang minerals) due to loss of water
increasing its density.

6. A method for production of micronized calcined tincal according to the claims 4 and 5 characterized with autogenic grinding process in which calcined clay shows grinding impact on calcined tincal by means of integral flights located in rotary furnace.

7. A method according to the claims 4 to 6 characterized with separation procedure performed through hot air drawn by air fan inside the furnace taking advantage of differences between densities of
micronized calcined tincal having bulk density of 0.15-0.3 g/cm³ and clay, subjected to heat treatment, having bulk density of 1.0 g/cm³ during first puffing of tincal or during autogenic grinding procedure.

8. A method for production of micronized calcined tincal according to claims 4-7 in which machines and equipments including rotational furnace with integral flights, dust cleaning unit (cyclone and filter), air fan and product conveyance elements are used.

9. A method for production of micronized calcined tincal according to claims 4-8 characterized with the following operation temperatures:
Temperature of furnace entrance (hot head) is minimum 300° C., and maximum 550° C.,
Temperature of middle of the furnace is minimum 130° C., and maximum 450° C.,
Temperature of furnace exit (cold head) is minimum 100° C., and maximum 250° C.,
Temperature of chimney (between the furnace and dust cleaning unit) is minimum 70° C., and maximum 200° C.,
Temperature of dust cleaning unit is minimum 60° C. and maximum 140° C.

10. A method for production of micronized calcined tincal according to the claims 4-9 characterized with the steps of
obtaining of calcined tincal enriched with B₂O₃ from cyclone, filter and the chimney exit at the end of the furnace, and
obtaining calcined clay that is weakened by B₂O₃ in the content of 1-5% from entry of furnace as waste.

11. A method according to the claims 1 to 10 characterized with realization of calcination-autogenic grinding-separation procedures in a single step in the same medium.

12. A method for production of micronized calcined tincal product according to claims 4 to 11 comprising the steps of:
condensation of water removed from the ore and water vapor carried into the system via air and combustion gases in the dust cleaning unit, due to the fact that operational temperature in the dust cleaning unit is low,
absorption of a part of condensed water vapor again by the micronized calcined tincal,
increase in the crystal water
decrease in B₂O₃ content.

13. Compacted calcined tincal product according to the claims 1-12 characterized with contents having same chemical properties, same contents of impurities and the same chemical formulation (Na₂B₄O₇.(1-5)H₂O) with the micronized calcined tincal product (having 45-62% B₂O₃ content, 8.0-30.0% loss on ignition; impurities by weight 3-12% (clay, dolomite); 1-5.0% MgO, 1-5.0% CaO, 1-3.0% SiO₂, 0.03-0.15% SO₃, 15-29% Na₂O, maximum 0.20% Fe₂O₃, maximum 0.25% Al₂O₃).

14. A compact calcined tincal product according to claim 13 characterized with physical features of 0-0.6% moisture, particle size of −6 mm and bulk density of 0.75-1.0 g/cm³.

15. A method for production of compacted calcined tincal product according to the claims 13 and 14 characterized with the steps of the production procedures;
obtaining without using any binding additive,
compacting micronized calcined tincal with low density by compressing under the high pressure,
subjecting to crushing sieving procedure.

16. A method for production of compacted calcined tincal according to claim 15 characterized with compacting procedure
including the steps of
supplying of calcined tincal as micronized grains in between the compactor plates,
getting out them as strips from the discs under the high pressure.

17. A method for production of compacted calcined tincal according to claims 15 and 16 characterized with crushing sieving procedure
including the steps of
breaking of the strips into pieces in the front breaker coupled to compactor feeding into crusher adjusting the size;
compacting the products which pass through the screen in sieving procedure in the second stage compactor under the sieve and
feeding back the products not passing through the eyes of the screen and remaining on the screen to crusher for grinding into proper size and taking the crushed products as final products.

18. A method for production of compacted calcined tincal according to claim 17 characterized with the step of:
applying pre-condensation process to the bulk density of the micronized calcined tincal before the micronized calcined tincal enters into the compactor
in order to increase compacting efficiency and capacity.

19. A method for production of compacted calcined tincal according to claims 15 to 18 characterized with the steps of:
adding water or water vapor into the product in pulverized manner (at least 1% of optimum product weight) mixing the product in the helix or another type mixer,
mixing with the materials (for example metal ball) having high density without abrasion nature within a tank adding dry water vapor or without charging any additive to the micronized calcined tincal,
decreasing and compressing the dust in volume by discharging air included in the micronized calcined tincal using the 1^{st} compactor in the pre-condensation process using two or more compactor in series,
performing pre-condensation process by making the bulk density of the product as 0.4-0.6 g/cm³ in average
in order to pre-condensation of the micronized calcined tincal.

20. A method for production of compacted calcined tincal according to claims 15 to 19 characterized with the steps of:
applying at least 4 ton/cm pressure to the disc surface in order to compacting the micronized calcined tincal subjected to the pre-condensation process,
applying at least 15 ton/cm pressure to the disc surfaces in order to compacting without performing pre-condensation process.

21. A method according to the claims 15 to 20 including the steps in which micronized calcined tincal having a particle size −250 micron in average and a bulk density of 0.15-0.3 gr/cm³ is fed into the compactor characterized with compacted calcined tincal product in the size of 3 mm and having a bulk density of 0.8 to 0.95 g/cm³.
